(19) United States
(12) Patent Application Publication
(10) Pub. No.: US 2014/0031121 A1
(43) Pub. Date: Jan. 30, 2014

(54) BROADCASTER MODE AND BROADCASTING FEATURES FOR GAMING ENVIRONMENTS

(71) Applicants: Mark Kern, Aliso Viejo, CA (US); Scott Rudi, Aliso Viejo, CA (US)

(72) Inventors: Mark Kern, Aliso Viejo, CA (US); Scott Rudi, Aliso Viejo, CA (US)

(21) Appl. No.: 13/558,158

(22) Filed: Jul. 25, 2012

(51) Int. Cl. A63F 13/00

(52) U.S. Cl. 463/33; 463/35; 463/32; 463/31

(57) ABSTRACT

A system and method for providing a broadcaster mode within a gaming environment is provided. The method includes receiving, via a networked gaming system, a request from a broadcaster for a display enhancement within the gaming environment. The broadcaster is a non-participant in a game occurring within the gaming environment. The method also includes providing, within the gaming environment, the display enhancement. A system is provided for facilitating broadcasting in a gaming environment. The system includes a server, coupled to a computing system, executing a video game program that provides the gaming environment. The video game program includes a broadcaster module that provides a broadcaster access to view the gaming environment. The video game program also includes an interactivity module that provides the broadcaster with one or more options for displaying information about the gaming environment. A non-transitory computer readable storage medium having embodied thereon a program is provided.

### CROSS REFERENCE TO RELATED APPLICATIONS

This Non-Provisional U.S. patent application is related to U.S. patent application Ser. No. 13/549,350, filed on Jul. 13, 2012, entitled “PERIPHERAL DEVICE CONTROL AND USAGE IN A BROADCASTER MODE FOR GAMING ENVIRONMENTS” which is hereby incorporated by reference herein in its entirety.

### FIELD OF THE INVENTION

The present technology relates generally to videogames and gaming environments, and more specifically, but not by way of limitation, to videogames and gaming environments that allow for a broadcaster mode within the gaming environment. In some instances, broadcasters may control a display of the gaming experience between active participants.

### BACKGROUND

Spectator modes within video games often allow for non-participating parties (e.g., spectators) to view game play or activities of active gaming participants (e.g., individuals playing the videogame). Video games may be viewed by spectators and commentary may be added by broadcasters to the visual component for enhancement of the viewing experience.

### SUMMARY OF THE INVENTION

According to some embodiments, the present technology may be directed to a method for providing a broadcaster mode within a gaming environment. The method includes receiving, via a networked gaming system, a request from a broadcaster for a display enhancement within the gaming environment. The broadcaster is a non-participant in a game occurring within the gaming environment. The method also includes providing, within the gaming environment, the display enhancement.

According to some embodiments, the present technology may be directed to a system that facilitates broadcasting a gaming environment. The system includes at least one server that is selectively coupleable to an end user computing system. The at least one server includes a processor configured to execute instructions. The instructions include a video game program that provides the gaming environment. The video game program includes a broadcaster module that provides a broadcaster access to view the gaming environment. The video game program also includes an interactivity module that provides the broadcaster with one or more options for displaying information about the gaming environment and receives a selection of the one or more options from the broadcaster.

According to some embodiments, the present technology may be directed to a non-transitory computer readable storage medium having embodied thereon a program. The program executable by a processor to perform a method providing a broadcaster mode within a gaming environment. The method includes receiving, via a networked gaming system, a request for a display enhancement within the gaming environment. The method also includes providing, within the gaming environment, the display enhancement.

### BRIEF DESCRIPTION OF THE DRAWINGS

FIG. 1 illustrates an exemplary architecture for practicing aspects of the present technology.

FIG. 2 illustrates an exemplary architecture for practicing further aspects of the present technology.

FIG. 3 is a flowchart of exemplary method for facilitating a broadcaster mode within a gaming environment.

FIG. 4 is an exemplary view of a gaming environment.

FIG. 5 is a block diagram of an exemplary computing system that may be utilized to practice aspects of the present disclosure.

FIG. 6 is another exemplary view of a gaming environment.

### DETAILED DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The broadcaster tool including a broadcaster mode provided herein provides special features for broadcasters, also known as shoutcasters. These broadcasters or shoutcasters may be sports announcers for video games or other e-sports. The broadcaster mode may call-up profiles, track objects, and/or call-up game and/or player statistics, etc. The suite of tools in the broadcaster mode may be used by shoutcasters, and not available to general players.

Individuals can stream gameplay, and talk over the gameplay, using a spectator mode. The present technology provides broadcast grade tools, including head-to-head statistics, highlighting, drawing, and or other broadcast grade tools that would be known to one of ordinary skill in the art with the present disclosure before them. A broadcaster mode may be controlled on a device, such as an iPad®, a specialized gaming laptop, or desktop and LCD screen. A secondary screen or multiple screens that show different aspects of a game may also likewise be utilized. A broadcast mode may enable high quality production values in e-sports broadcasting and commentary, and may facilitate the licensing of e-sports broadcasts on television.

According to some embodiments, the present technology may provide broadcaster features within videogames, and specifically the gaming environment of the videogame. Exemplary end user computing systems include, but are not limited to, personal computers, mobile devices, video game consoles, and so forth. Furthermore, broadcaster requests may be received from input devices associated with the end user computing systems, such as a keyboard, a microphone, a Bluetooth headset, a mouse, a motion-based input device, a webcam, and so forth.

Generally speaking, the term “broadcaster” may be understood to include a non-participating actor that is allowed to view and/or image the gaming environment, and in some instances, for the purpose of broadcasting a “play-by-play” commentary on the action of videogame. Broadcasters can view the on-going gameplay in a gaming environment via a broadcaster mode, and may add additional material or manipulate the view of the video game to enhance the analysis provided by the broadcaster. In contrast, an active participant is an actor that directly interacts with the gaming environment (e.g., a player).

A broadcaster mode is provided for a video game environment. The broadcaster mode provides various features to a broadcaster to facilitate the live or delayed coverage of game play in a video game. Features provided within a broadcaster mode include one-touch database access and one touch instant replay.

The broadcaster mode allows a player to access additional, specialized portions of the video game program that provide a tool or a suite of tools for the amateur, professional, or semi-professional broadcasting of e-Sports games on the web, television, or film, either live or pre-recorded. Unlike broadcast mode in video, the present technology may be utilized in a real-time game simulation, which can be manipulated at will, giving the broadcaster more control over displaying the game, for example, rewinding it, changing camera angles, etc.

While other games feature a spectator mode that can show re-simulated gameplay, none offer the highly specialized professional tools and access to data that enable a broadcaster to optimize the game for live streaming over television or the web, with professional controls and configurable user interfaces for the specific purpose of broadcasting.

Regular players may not be able to access this mode until they are approved as broadcasters by a game administrator. This can be accomplished through several methods. For example, a game moderator may flag a player for broadcast status on the server, which will enable additional client and server functionality. In addition, the player may apply for broadcaster status via the game's internal user interface (UI), or via a separate web site. The process may include presenting the broadcaster with a new license agreement catered to broadcasting, automatically proceeding when the agreement is accepted, and then presenting the broadcaster with a nominal broadcasting fee which must be paid (monthly or annually) to have access to the additional software features for broadcast mode.

The broadcaster mode may enable special features not available to other gamers to professionally manage the presentation of broadcast and game graphics over a live or recorded video stream. These may include custom controls for cameras, player data and game stats, score presentation, replays, and more. In addition, the broadcast mode may enable support for additional hardware to control the application, including secondary monitors, specialized keyboards, displays and mobile devices.

One feature provided in a broadcast mode may be access to a database, and more specifically, a one touch broadcast mode database access. Using this feature, the broadcast mode may allow access for broadcasters to an array of player and game map information not normally available in other modes of the game. Broadcast mode may allow wide access to the game server's database of logs including: 1) current leaderboards and rankings; 2) individual player statistics and information; 3) heat maps (maps graphing data such as where players die, paths they travel, etc.); and 4) other historical performance data for players both individually and in the aggregate.

Some exemplary embodiments enable provide broadcasters with access to certain privileged parts of the database. In addition, the exemplary system allows broadcaster to custom configure, select and choose how they want to display the information such that a broadcaster can call up custom UI panels at the touch of a button to display the information.

One of the broadcaster mode features includes “player cards” that can be called up during the broadcast of a game. These cards feature data pertinent to a player's success record, win-loss ratio, kill-death ratio, or other suitable information that would be known to one of ordinary skill in the art. Other game player data gleaned from player logs, for a particular game or for a history of the game player or game avatar, may be accessed by a broadcaster, who can determine which information she wishes to display as the default information on the player card. This information may be bound to the game player card with a single touch control or keystroke. This data selection may be used as a default data selection applicable to other players when accessed by the broadcaster. The other player or players used in a comparison may not be participating in the present game being broadcast, thereby enabling historical comparisons of past players, for example.

A one touch instant replay mode may be provided in the broadcaster mode. A single press of a button may rewind gameplay to show a 30 second (or N second) instant replay of the action to his or her audience. Unlike video, this rewind is of live, recorded game data, where the simulation of the game is rewound by a set amount. While other games offer a rewind mode, none allow for the convenience that a broadcaster would need to set replay of a predetermined duration of time at a single key press.

Such replays may also be custom configured by time duration, or, because the feed is actual gameplay simulation and not video, tied to key events such as “x seconds before last kill” or even specific to individual players “when player x shoots and kills player y.”

For example, a broadcaster may desire an instant replay of 30 seconds. The broadcaster may open a control UI in the broadcaster mode and assign a 30 second rewind. Additionally, the broadcaster may bind the rewind command to the “R” key on the keyboard. Now, whenever the “R” key is pressed, the local simulation of the game will rewind to the thirty second mark in the past, without interrupting the regular flow of the game for the rest of the players. At the conclusion of the rewind, the view may automatically resume at the current point in the game, or may scan forward at double or another multiple speed up to the current point, or may offer a choice to the broadcaster to continue viewing at normal speed, jump, or speed forward.

Another example allows the broadcaster to rewind when an important player dies. The broadcaster may set another rewind command to rewind to the exact moment that the last player or a named player dies, and/or further configure it to go back another ten seconds before then to capture the video image of who shot the named player. This rewind command may be bound to the “P” key so as not to interfere with the regular “R” key thirty second rewind. When the player dies, pressing the “P” key commands a rewind of the game to the exact time that player died, and then rewind an additional ten seconds from there. This occurs without interrupting the actual game being held at that moment.

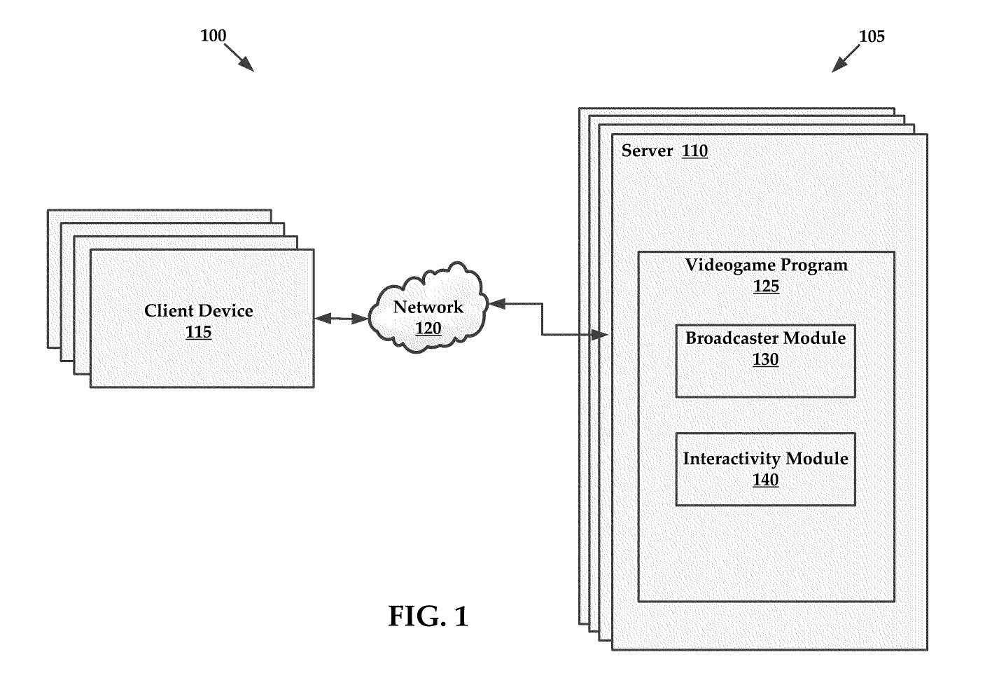

FIG. 1 illustrates an exemplary architecture 100 for practicing aspects of the present technology. The architecture 100 is shown as including a networked gaming system 105 implemented within the context of a server 110 (shown within a plurality of web servers). The networked gaming system 105 may facilitate the operation of a video game program 125 that generates a gaming environment.

An end user computing system 115 (shown within a plurality of end user computing systems) may be communicatively coupled to the server 110 via a network connection 120. It will be understood that the network connection 120 may include any private or public network such as the Internet.

When the end user computing system 115 is communicatively coupled to the server 110, broadcasters may interact with the gaming environment generated by a video game program 125 using the end user computing system 115. Likewise, active participants may interact with the gaming environment using the end user computing system 115.

In some embodiments, the networked gaming system 105 may be implemented as a cloud-based computing environment. In general, a cloud-based computing environment is a resource that combines the computational power of a large grouping of processors and/or that combines the storage capacity of a large grouping of computer memories or storage devices. For example, systems that provide a cloud resource may be utilized exclusively by their owners. These systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

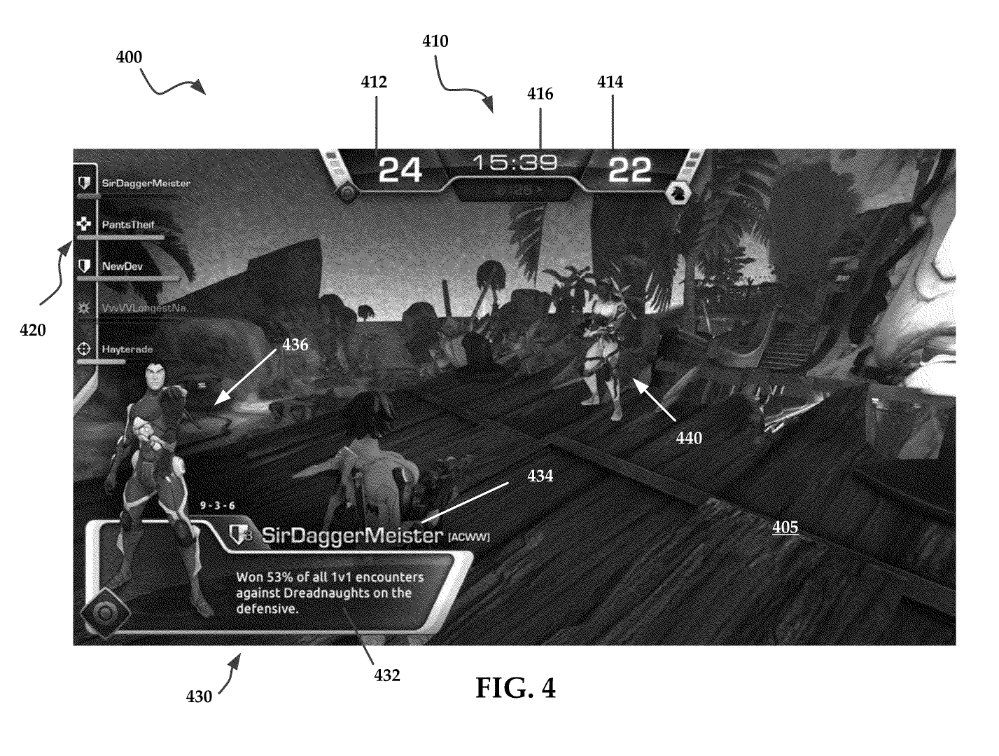

According to some embodiments, the networked gaming system 105 may be generally described as a particular purpose computing environment that includes executable instructions stored in memory. These instructions, when executed by the processor provide interactive broadcaster features within the gaming environment. More specifically, the networked gaming system 105 may execute the video game program 125 to generate a gaming environment (see FIG. 4 for an exemplary view of a gaming environment). The video game program 125 may comprise one or more mechanisms for facilitating broadcaster interaction with the gaming environment.

In accordance with the present technology, the networked gaming system 105 may facilitate a broadcast of a gaming environment by providing a broadcaster with access to a view of the gaming environment and special features to enhance the broadcast of the game to spectators. The special features may include the ability to rewind play, highlight a player or zone of action, display player data, display game data, and/or manipulate a view of game play by zooming and/or changing a camera perspective. The networked gaming system 105 may receive a selection of the one or more features from the broadcaster and effect a change of the view of the gaming environment based upon the selection.

In some embodiments, the executable instructions such as a video game program 125 that facilitates a gaming environment may reside on the server 110. In some instances, the video game program 125 may comprise a broadcaster module 130 and an interactivity module 140. In other embodiments, the broadcaster module 130 and the interactivity module 140 may cooperate together as a standalone plug-in or module that is separate from the video game program 125.

It is noteworthy that the server 110 may include additional modules, engines, or components, and still fall within the scope of the present technology. As used herein, the term “module” may also refer to any of an application-specific integrated circuit (ASIC), an electronic circuit, a processor (shared, dedicated, or group) that executes one or more software or firmware programs, a combinational logic circuit, and/or other suitable components that provide the described functionalities.

According to some embodiments, the broadcaster module 130 may provide a broadcaster access to view the gaming environment, while the interactivity module 140 provides the broadcaster with one or more features for displaying the gaming environment and receives a selection of the one or more features from the broadcaster.

With regard to the video game program 125, the video game program 125 may comprise any type of video game application/program/set of executable instructions, including but not limited to, a multiplayer networked video game such as a MMORPG (massively multiplayer online role-playing game), a first-person shooter, a strategy game, role playing games, action games, arcade games, simulation games, and so forth. Other suitable types of video games that would be known to one of ordinary skill in the art are also likewise contemplated for use in accordance with the present technology. Active participants (e.g., game players) may interact with the gaming environment that is generated by the video game program 125. With regard to conventional videogames, the gaming experience for active participants is largely, if not entirely, predetermined by game designers and encoded into the videogame. Therefore, other than actions performed within the gaming environment by other active participants, the gaming experience of an active participant is preconfigured into the executable instructions for the videogame.

Advantageously, the present technology allows for broadcaster interaction with the display of the gaming environment. Broadcaster interaction may comprise rewinding, changing camera angles, and changing zoom levels. In other instances, the interaction may be highlighting a player with a glow, encircling a player or group of players with a pre-programmed shape, or may be a manually input line or lines. The broadcaster input may be received from an end user computing system in the form of button click, mouse clicks, cursor movements, keystrokes, accelerometer sensed input, gesture-based input, motion sensing input, facial recognition, or any combinations thereof.

According to some embodiments, the broadcaster module 130 may be executed to allow for broadcaster access to the gaming environment. This feature may be referred to as “broadcaster mode.” Broadcasters may gain access to views of the gaming environment and graphical overlays and/or other features from a graphical user interface that is generated by the video game program 125. The broadcaster environment may include a view of at least a portion of the gaming environment and/or a plurality of views of different portions of the gaming environment. In some instances, a broadcaster may be allowed to follow a selected or specified active participant. In other embodiments, the broadcaster may roam through the gaming environment in a free-form mode. Exemplary views of the gaming environment may comprise a first-person perspective view (relative to the broadcaster or an active participant, a top-down perspective view, and so forth. The broadcaster module 130 may provide the broadcaster with a plurality of view features such as zoom, pan, replay, tilt, and so forth.

In some embodiments, the video game program 125 may determine active participants located proximate the broadcaster's viewpoint. Alternatively, if the broadcaster has chosen to follow a particular active participant, the video game program 125 may track this information as well.

According to some embodiments, the interactivity module 140 may provide the broadcaster with one or more features for displaying the gaming environment.

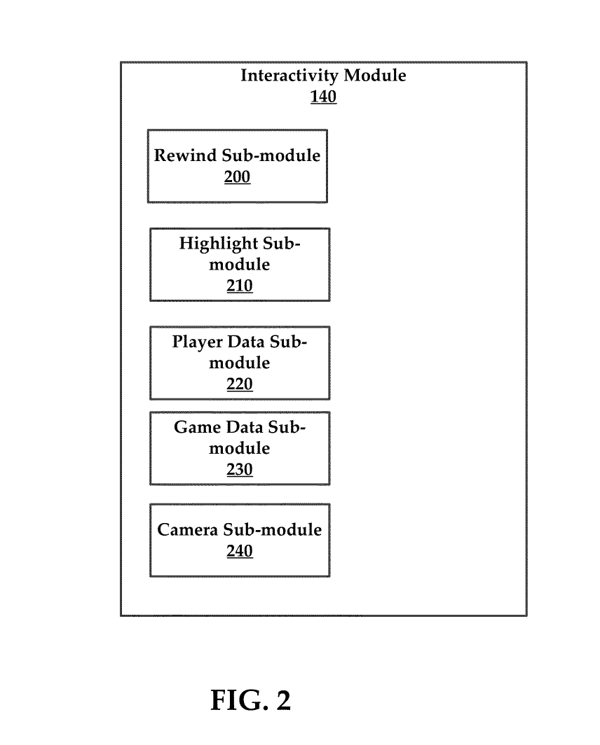

FIG. 2 illustrates an exemplary architecture of interactivity module 140 for practicing aspects of the present technology. Interactivity module 140 is shown as including a rewind sub-module 200, highlight sub-module 210, player data sub-module 220, game data sub-module 230, and camera sub-module 240. Alternatively, interactivity module 140 may include more or fewer sub-modules.

Rewind sub-module 200 may operate to receive setting commands from a user or broadcaster, for instance presetting rewind amounts, tying to specific game events (for example game participant deaths, contacts, proximity, or hits), and/or binding specific keys to specific commands for one-touch, via one key activation, access to the specified command. For instance, the “R” key may be an automatic thirty second (or N second) rewind. Likewise, the “P” key may rewind to ten seconds (or N seconds) prior to a specific player's death.

Highlight sub-module 210 may operate to receive instructions from a broadcaster to highlight a particular game participant, game participants, and/or zone of activity. Player data sub-module 220 may operate to display game data relating to a specific game participant. Such game player data may include number of kills, number of deaths, success against particular opponents, and/or any other data specific to a particular game participant. Game data sub-module 230 may operate to display game data relating generally to a game. Such game data may include team scores, time remaining, game participants and alliances, if any, and/or any other data relative to a particular game. Camera sub-module 240 may operate to enable a broadcaster to tailor the view of the game environment, for instance by focusing on a particular participant or group of participants, a particular area of interest, and/or a particular conflict. Camera perspective may also be adjusted to assist the broadcaster in presenting a commentary on the gameplay.

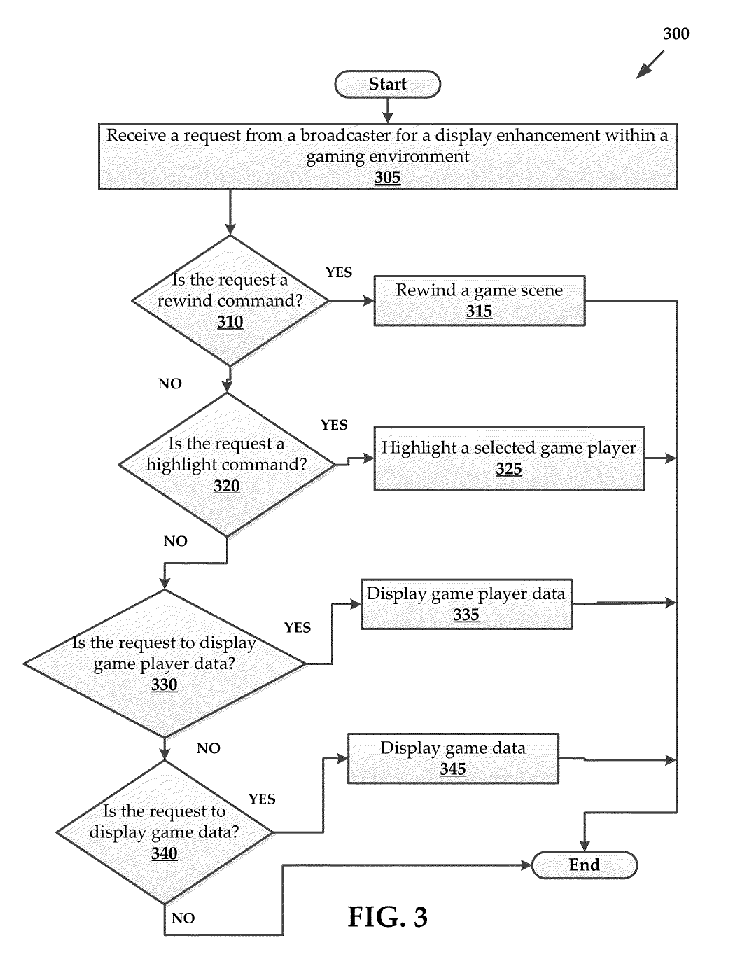

FIG. 3 is a flowchart of an exemplary method 300 for facilitating a broadcaster mode within a gaming environment. In accordance with the present disclosure, the method 300 may flow from the start oval to step 305, which indicates to receive a request from a broadcaster for a display enhancement within a gaming environment. From step 305, the flow proceeds to decision 310, which asks whether the request is a rewind command. If the answer to decision 310 is affirmative, the flow proceeds to stop 315, which indicates to rewind a game scene. From step 315, the flow proceeds to the end oval. If the answer to decision 310 is negative, the flow proceeds to decision 320, which asks whether the request is a highlight command. If the answer to decision 320 is affirmative, the flow proceeds to step 325, which indicates to highlight a selected game player. From step 325, the flow proceeds to the end oval. If the answer to decision 320 is negative, the flow proceeds to decision 330, which asks whether the request is a request to display game player data. If the answer to decision 330 is affirmative, the flow proceeds to step 335, which indicates to display game player data. From step 335, the flow proceeds to the end oval. If the answer to decision 330 is negative, the flow proceeds to decision 340, which asks whether the request is a request to display game data. If the answer to decision 340 is affirmative, the flow proceeds to step 345, which indicates to display game data. From step 345, the flow proceeds to the end oval. If the answer to decision 340 is negative, the flow proceeds to the end oval.

Method 300 may be performed iteratively, meaning that it proceeds from the end oval to the start oval. Alternatively, any of the decision operations may be removed, other decision operations may be added, and the order of the decision operations may be changed.

FIG. 4 is an exemplary view 400 of a gaming environment 405. Gaming environment 405 is shown with active participants, including player 440, within a landscape. It will be understood that this view of the gaming environment that is shown in FIG. 4 is an exemplary view that may be provided to a broadcaster and/or any viewers of the broadcast. View 400 of FIG. 4 approximates the same view that the active participant views in a third-person view mode. View 400 includes several features specific to a broadcast mode.

View 400 includes game data area 410 on the top center edge of view 400. Alternatively game data area 410 may be in any appropriate portion of view 400. Game data area 410 includes blue team score 412, red team score 414, and time remaining 416. Any other appropriate game data may be include in game data area 410, for instance time elapsed. Game participant information 420 is displayed in an area separate from game data area 410, but may alternatively be positioned in the same area. Game data area 410 and game participant information 420 may be customized by a broadcaster to display only the information selected by the broadcaster for display.

View 400 also includes player data area 430 on the lower left side of view 400. Alternatively player data area 430 may be in any appropriate portion of view 400. Player data area 430 includes specific information 432 selected by the broadcaster for display, as well as player name 434 and player avatar 436. Both the game data and the player data shown in view 400 may be automatically pulled from the servers of the video game, and in particular may be culled from a log of all historical activity by a player or a group of players within a game.

A broadcaster utilizing the system provided herein may bring up some or all of the information in game data area 410 or player data area 430 at the press of a button, and may remove the display also at the press of a button. The broadcaster may also highlight player at the press of a button, and view 400 shows player 440 highlighted. Highlighting enables easy identification of a player, particular to associate the commentary of the broadcaster with the topic of their commentary. Additionally, as discussed above, a broadcaster may rewind at the touch of a button, and may tie a specific rewind command to a game event, for instance the death of player 440.

The request may include a rewind command, and the rewind command may automatically rewind a preset amount. The preset amount may be configurable by a broadcaster. The rewind command may automatically rewind a preset amount before a specified game event. The request may include a command to highlight an avatar of a game participant.

The request may include a request to display data relating to a game player, and the data may be active game data and/or historical performance data. The data may be selected by a broadcaster from a set of possible data and arranged in a game card according to a template selected by the broadcaster. The request may include a request to display data relating to a game. The request may include a request to display a map and/or a map overlay illustrating game data and/or game player data. The map overlay may include a heat map graphically illustrating the game data and/or the game player data.

The request may include a request to change a viewing angle and/or a zoom quantity. The interactivity module may include a rewind sub-module, and the rewind sub-module may provide a rewind command to the broadcaster. The rewind command may automatically rewind a data stream representing game play of the video game a preset amount and/or the preset amount before a specified game event. The preset amount may be configurable by a user.

The interactivity module may include a highlight sub-module providing a command to the broadcaster to highlight an avatar of a game participant. The interactivity module may include a player data display sub-module providing a command to the broadcaster to display data relating to a game player. The data may be active game data and/or historical performance data. The data may be selected by the broadcaster from a set of possible data and arranged in a game card according to a template selected by the broadcaster.

The interactivity module may include a game data display sub-module providing a command to the broadcaster to display data relating to a game. The data may be a map and/or a map overlay illustrating one of game data and game player data. The map overlay may include a heat map graphically illustrating the game data and/or the game player data. The interactivity module may include a camera sub-module providing a command to the broadcaster to change a viewing angle and/or a zoom quantity.

The request may include a rewind command, a command to highlight an avatar of a game participant, and/or a request to display data relating to a game player. The request may include a drawing overlay command. The drawing overlay may provide a manually input line and/or a preprogrammed line over a visual image of the gaming environment.

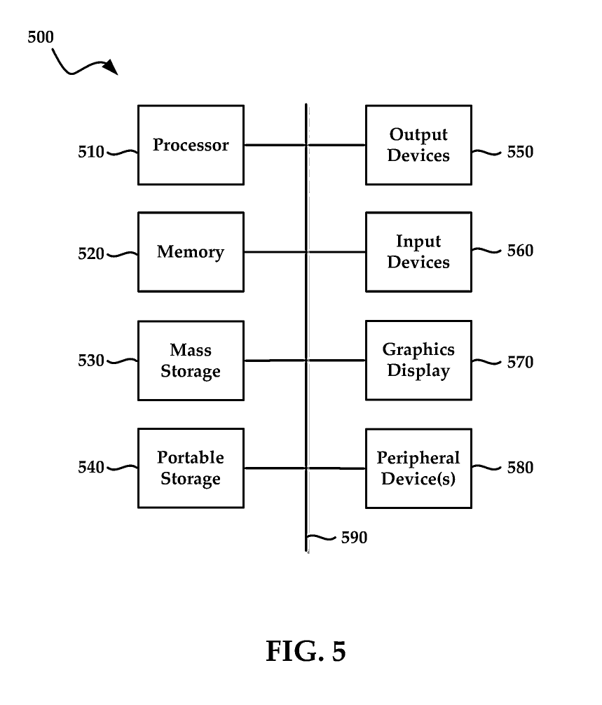

FIG. 5 illustrates an exemplary computing system 500 that may be used to implement an embodiment of the present technology. Either of the end user computing system 115 and/or the server 110 may include one or more of the components of computing system 500. The computing system 500 of FIG. 5 includes one or more processors 510 and memory 520. Main a memory store 520 stores, in part, instructions and data for execution by the one or more processors 510. Main a memory store 520 can store the executable code when the system 500 is in operation. The system 500 of FIG. 5 may further include a mass storage device 530, portable storage medium drive(s) 540, output devices 550, user input devices 560, a graphics display 570, and other peripheral device(s) 580.

The components shown in FIG. 5 are depicted as being connected via a single bus 590. The components may be connected through one or more data transport means. The one or more processor 510 and main a memory store 520 may be connected via a local microprocessor bus, and the mass storage device 530, peripheral device(s) 580, portable storage device 540, and graphics display 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present technology for purposes of loading that software into main a memory store 520.

Portable storage medium drive(s) 540 operate in conjunction with a portable non-volatile storage medium, such as a floppy disk, compact disk or digital video disc, to input and output data and code to and from the computing system 500 of FIG. 5. The system software for implementing embodiments of the present technology may be stored on such a portable medium and input to the computing system 500 via the portable storage medium drive(s) 540.

Input devices 560 provide a portion of a user interface. Input devices 560 may include an alphanumeric keypad, such as a keyboard, for inputting alphanumeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripherals device(s) 580 may include any type of computer support device to add additional functionality to the computing system. Peripheral device(s) 580 may include a modem or a router.

The components contained in the computing system 500 of FIG. 5 are those typically found in computing systems that may be suitable for use with embodiments of the present technology and are intended to represent a broad category of such computer components that are well known in the art. Thus, the computing system 500 of FIG. 5 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In alternative or additional exemplary embodiments, fast forward controls may be provided as well as rewind controls. Ability bar displays may be provided as well as various other graphic refinements. A victory screen with a scoreboard may be provided at the end of the match.

Exemplary embodiments provide a time slider or time/stream bar to click on to cue to a particular time in the match. Time anchors, in which the broadcaster may press a key to drop a time anchor and instantly cue to that time anchor by clicking on its icon in the time/stream bar, may also be provided.

Automatic production of “greatest hits” footage may be generated by objective events, headshots, and any other interesting criteria included in the data collected during a game event. The greatest hits footage may be displayed at the end of a match, or at any other appropriate time, possibly on the command of a broadcaster.

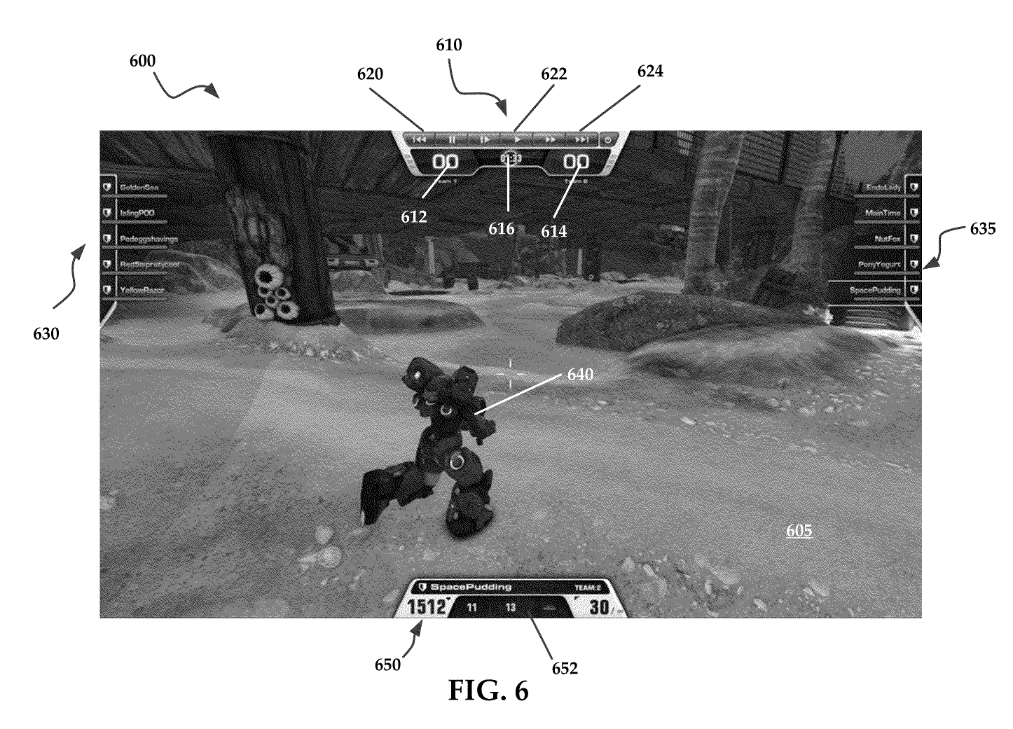

FIG. 6 is an exemplary view 600 of a gaming environment 605. Gaming environment 605 is shown with one active participant, player 640, within a landscape. It will be understood that this view of the gaming environment that is shown in FIG. 6 is an exemplary view that may be provided to a broadcaster and/or any viewers of the broadcast. View 600 of FIG. 6 approximates the same view that the active participant views in a third-person view mode. View 600 includes several features specific to a broadcast mode.

View 600 includes game data area 610 on the top center edge of view 600. Alternatively game data area 610 may be in any appropriate portion of view 600. Game data area 610 includes blue team score 612, red team score 614, and time remaining 616. Any other appropriate game data may be include in game data area 610, for instance time elapsed. Game data area may also include play controls, for instance skip back 620, play 622, and skip forward 624. Additional play controls for instance scan backward, scan forward, and pause may also be provided.

Team participant information 630 identifies, and potentially shows particular status information, for members of one team in a match. Team participant information 635 identifies, and potentially shows particular status information, for members of an opposing team in the match. Team participant information 630 and 635 may be displayed in areas separate from game data area 610, but may alternatively be positioned in the same area. Game data area 610 and team participant information 630 and 635 may be customized by a broadcaster to display only the information selected by the broadcaster for display.

View 600 also includes player data area 650 on the lower center area of view 600. Alternatively player data area 650 may be in any appropriate portion of view 600. Player data area 650 includes specific information 652 selected by the broadcaster for display, for example number of kills, lives remaining, energy, ammunition, weapons, or any other appropriate information. Both the game data and the player data shown in view 600 may be automatically pulled from the servers of the video game, and in particular may be culled from a log of all historical activity by a player or a group of players within a game.

A broadcaster utilizing the system provided herein may bring up some or all of the information in game data area 610 or player data area 650 at the press of a button, and may remove the display also at the press of a button. The broadcaster may also highlight player 640 at the press of a button. Highlighting enables easy identification of a player, particular to associate the commentary of the broadcaster with the topic of their commentary. Additionally, as discussed above, a broadcaster may rewind at the touch of skip back 620 or alternatively by a rewind button or scan back button, and may tie a specific rewind command to a game event, for instance the death of player 640. Skip back 620 and/or skip forward 624 may skip to an automatically inserted time anchor, or to a time anchor manually inserted by the broadcaster.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A method for providing a broadcaster mode and a spectator mode within a gaming environment, the method comprising:
receiving at a server, via a networked gaming system, a request from a broadcaster for a display enhancement within the gaming environment, the broadcaster being a non-participant in a game occurring within the gaming environment;
providing the display enhancement to the broadcaster for viewing on a secondary screen in the broadcaster mode within the gaming environment, the display enhancements including data about the game and a view of the game not available in spectator mode;
receiving a commentary from a broadcaster, the commentary based on the display enhancement viewed by the broadcaster on the secondary screen in the broadcaster mode; and
broadcasting the commentary to a plurality spectators viewing the game in the spectator mode within the gaming environment.

2. The method according to claim 1, wherein the request comprises a rewind command.

3. The method according to claim 2, wherein the rewind command automatically rewinds a preset amount, the preset amount being configurable by a broadcaster.

4. The method according to claim 2, wherein the rewind command automatically rewinds a preset amount before a specified game event, the preset amount being configurable by a broadcaster.

5. The method according to claim 1, wherein the request comprises a command to highlight an avatar of a game participant.

6. The method according to claim 1, wherein the request comprises a request to display data relating to a game player, the data being one of active game data and historical performance data.

7. The method according to claim 6, wherein the data is selected by a broadcaster from a set of possible data and arranged in a game card according to a template selected by the broadcaster.

8. The method according to claim 1, wherein the display enhancement comprises a map and map overlay.

9. The method according to claim 1, further comprising:
receiving a application for broadcaster status from a player of the game; and
approving the player as a broadcaster.

10. The method according to claim 8, wherein the map overlay comprises a heat map graphically illustrating the one of the game data and the game player data.

11. The method according to claim 1, wherein the request comprises a request to change at least one of a viewing angle and a zoom quantity.

12. A system that facilitates broadcasting a gaming environment to a plurality of spectators, the system comprising:
at least one server that is selectively coupleable to an end user computing system, the at least one server comprising a processor configured to execute instructions that comprise:
a video game program that provides the gaming environment to a broadcaster in a broadcaster mode and to the plurality of spectators in a spectator mode, the video game program comprising:
a broadcaster module that provides a broadcaster access to view the gaming environment in the broadcaster mode on a secondary screen; and
an interactivity module that provides the broadcaster with one or more options in broadcaster mode for displaying information about the gaming environment, the one or more options not available in the spectator mode, and receives a selection of the one or more options from the broadcaster for manipulating a view of the game for broadcasting to the plurality of spectators in spectator mode.

13. The system according to claim 12, wherein the interactivity module comprises a rewind sub-module, the rewind sub-module providing a rewind command to the broadcaster, the rewind command automatically rewinding a data stream representing game play of the video game one of a preset amount and the preset amount before a specified game event, the preset amount being configurable by a user.

14. The system according to claim 12, wherein the interactivity module comprises a highlight sub-module providing a command to the broadcaster to highlight an avatar of a game participant.

15. The system according to claim 12, wherein the interactivity module comprises a player data display sub-module providing a command to the broadcaster to display data relating to a game player, the data being one of active game data and historical performance data, the data being selected by the broadcaster from a set of possible data and arranged in a game card according to a template selected by the broadcaster.

16. The system according to claim 12, wherein the interactivity module comprises a game data display sub-module providing a command to the broadcaster to display data relating to a game, the data being one of a map and a map overlay illustrating one of game data and game player data, the map overlay comprising a heat map graphically illustrating the one of the game data and the game player data.

17. The system according to claim 12, wherein the interactivity module comprises a camera sub-module providing a command to the broadcaster to change at least one of a viewing angle and a zoom quantity.

18. A non-transitory computer readable storage medium having embodied thereon a program, the program executable by a processor to perform a method providing a broadcaster mode and a spectator mode within a gaming environment, the method comprising:
receiving, via a networked gaming system, a request for a display enhancement in the broadcaster mode within the gaming environment;
providing, within the gaming environment, the display enhancement to the broadcaster mode;
receiving an analysis of the game environment based on the display enhancement; and
providing, within the gaming environment, the analysis to the spectator mode.

19. The non-transitory computer readable storage medium of claim 18, wherein the request comprises at least one of a rewind command, a command to highlight an avatar of a game participant, and a request to display data relating to a game player.

20. The non-transitory computer readable storage medium of claim 18, wherein the request comprises a drawing overlay command, the drawing overlay providing one of a manually input line and a preprogrammed line over a visual image of the gaming environment.
